(19) United States
(12) Patent Application Publication
(10) Pub. No.: US 2025/0192167 A1
(43) Pub. Date: Jun. 12, 2025

(54) NEGATIVE ELECTRODE AND RECHARGEABLE LITHIUM BATTERY INCLUDING SAME

(71) Applicant: SAMSUNG SDI CO., LTD., Yongin-si (KR)

(72) Inventors: Changsu SHIN, Yongin-si (KR); Dae-Hyeok LEE, Yongin-si (KR); Hee Seon CHOI, Yongin-si (KR); Soonbong CHOI, Yongin-si (KR); Minyeong SONG, Yongin-si (KR)

(21) Appl. No.: 18/741,458

(22) Filed: Jun. 12, 2024

(30) Foreign Application Priority Data
Dec. 8, 2023 (KR) 10-2023-0178037

(51) Int. Cl. H01M 4/485; H01M 4/02; H01M 4/36; H01M 4/38; H01M 4/583; H01M 4/62; H01M 10/0525

(52) U.S. Cl. CPC H01M 4/485; H01M 4/364; H01M 4/366; H01M 4/386; H01M 4/583; H01M 4/625; H01M 10/0525; H01M 2004/021; H01M 2004/027

(57) ABSTRACT

A negative electrode active material and a rechargeable lithium battery including the same are provided. The negative electrode active material includes a M-included nano zirconia (where, M is Y₂O₃, CeO₂, or Sc₂O₃) with a particle diameter of about 300 nm or less, a nano silicon, and an amorphous carbon.

### CROSS-REFERENCE TO RELATED APPLICATION

This application claims priority to and the benefit of Korean Patent Application No. 10-2023-0178037, filed on Dec. 8, 2023, in the Korean Intellectual Property Office, the entire content of which is incorporated herein by reference.

### BACKGROUND

### 1. Field

According to one or more embodiments, the present disclosure relates to a negative electrode and a rechargeable lithium battery including the same.

### 2. Description of the Related Art

Recently, the rapid increases of electronic devices such as mobile phones, laptop computers, electric vehicles, and/or the like utilizing batteries require, or there is an increase in demand or desire for, small and lightweight rechargeable batteries with relatively high energy density and relatively high capacity. As a result, development and research for improving the performance characteristics of rechargeable lithium batteries are actively being studied or pursued.

A rechargeable lithium battery includes a positive electrode and a negative electrode which include active materials being capable of intercalating and deintercalating lithium ions. The batteries also include an electrolyte and generate electrical energy due to oxidation and reduction reactions if (e.g., when) lithium ions are intercalated and deintercalated into and/or out from the positive electrode and the negative electrode, respectively.

### SUMMARY

One or more aspects are directed toward a negative electrode exhibiting excellent or suitable thermal safety.

One or more aspects are directed toward a rechargeable lithium battery including the negative electrode.

Additional aspects will be set forth in part in the description which follows and, in part, will be apparent from the description, or may be learned by practice of the presented embodiments of the disclosure.

One or more embodiments provide a negative electrode active material including a M-included nano zirconia (where, M is Y₂O₃, CeO₂, or Sc₂O₃), with a particle diameter of about 300 nanometer (nm) or less); a nano silicon; and an amorphous carbon.

One or more embodiments provide a rechargeable lithium battery including a negative electrode including the negative electrode active material; a positive electrode; and an electrolyte.

A negative electrode active material according to one or more embodiments may exhibit excellent or suitable thermal electrochemical characteristic.

### BRIEF DESCRIPTION OF THE DRAWINGS

FIGS. 1-4 are each a schematic view illustrating a rechargeable lithium battery according to one or more embodiments.

### DETAILED DESCRIPTION

Hereinafter, specific embodiments are described in more detail so that those of ordinary skill in the art can easily implement them. Examples of which are illustrated in the accompanying drawings, wherein like reference numerals refer to like elements throughout, and duplicative descriptions thereof may not be provided. Accordingly, the embodiments are merely described, by referring to the drawings, to explain aspects of the present description. However, these embodiments are merely examples, the present disclosure may be embodied in many different forms and is not limited thereto, but rather, the present disclosure is defined by the scope of the claims.

Herein, it should be understood that terms such as “comprises,” “comprise,” “comprising,” “includes,” “including,” “include,” “having,” “has,” and/or “have” are intended to designate the presence of an embodied aspect, number, operation, element, and/or any suitable combination thereof, but it does not preclude the possibility of the presence or addition of one or more other feature, number, operation, element, and/or any suitable combination thereof.

In the drawings, the thickness of layers, films, panels, regions, and/or the like, are exaggerated for clarity wherein like reference numerals designate like elements, and duplicative descriptions thereof may not be provided throughout the specification. As utilized herein, if (e.g., when) a definition is not otherwise provided, it will be understood that if (e.g., when) an element such as a layer, film, region, or substrate is referred to as being “on” another element, it may be directly on the other element or intervening elements may also be present. In contrast, if (e.g., when) an element is referred to as being “directly on” another element, there are no intervening elements present.

The terminology utilized herein is utilized to describe embodiments only, and is not intended to limit the present disclosure. Unless otherwise specified in the specification, the singular expressions “a,” “an,” and “the” include the expressions in plural, including “at least one.”

Unless otherwise specified, “A or B” may indicate “includes A, includes B, or includes A and B”.

As utilized herein, the term “combination thereof may include a mixture, a laminate, a complex, a copolymer, an alloy, a blend, a reactant of constituents.

In one or more embodiments, the term “layer” herein includes not only a shape formed on the whole surface if (e.g., when) viewed from a plan view, but also a shape formed on a partial surface.

It will be understood that, although the terms “first,” “second,” “third,” and/or the like may be utilized herein to describe one or more suitable elements, components, regions, layers and/or sections, these elements, components, regions, layers and/or sections should not be limited by these terms. These terms are only utilized to distinguish one element, component, region, layer or section from another element, component, region, layer, or section. Thus, a first element, component, region, layer, or section described herein may be termed a second element, component, region, layer or section without departing from the teachings set forth herein.

As utilized herein, the term “and/or” includes any, and all, combinations of one or more of the associated listed items. Expressions such as “at least one of,” “one of,” and “selected from,” if (e.g., when) preceding a list of elements, modify the entire list of elements and do not modify the individual elements of the list. For example, the expressions “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

Spatially relative terms, such as “beneath,” “below,” “lower,” “above,” “upper” and/or the like, may be utilized herein to easily describe the relationship between one element or feature and another element or feature. It will be understood that the spatially relative terms are intended to encompass different orientations of a device in utilization or operation in addition to the orientation illustrated in the drawings. For example, if (e.g., when) the device in the drawings is turned over, elements described as “below” or “beneath” other elements or features will be oriented “above” the other elements or features. Thus, the example term “below” can encompass both (e.g., simultaneously) the orientations of above and below. The device may be otherwise oriented (rotated 90 degrees or at other orientations), and the spatially relative terms utilized herein may be interpreted accordingly.

The terminology utilized herein is utilized for the purpose of describing particular embodiments only, and is not intended to limit the present disclosure. Unless otherwise defined, all terms (including chemical, technical and scientific terms) utilized herein have the same meaning as commonly understood by one of ordinary skill in the art to which this disclosure pertains. It will be further understood that terms, such as those defined in commonly utilized dictionaries, should be interpreted as having a meaning that is consistent with their meaning in the context of the related art and the present disclosure, and will not be interpreted in an idealized or overly formal sense.

Example embodiments are described herein with reference to cross-sectional views, which are schematic views of idealized embodiments. As such, variations from the shapes of the illustrations as a result, for example, of manufacturing techniques and/or tolerances, are to be expected. Thus, embodiments described herein should not be construed as being limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the drawings are schematic in nature and their shapes are not intended to illustrate the precise shape of a region and are not intended to limit the scope of the present claims.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item.

In this context, “consisting essentially of” refers to that any additional components will not materially affect the chemical, physical, optical or electrical properties of the semiconductor film.

Further, in this specification, the phrase “on a plane,” or “plan view,” refers to viewing a target portion from the top, and the phrase “on a cross-section” refers to viewing a cross-section formed by vertically cutting a target portion from the side.

As utilized herein, if (e.g., when) a definition is not otherwise provided, a particle diameter may be an average particle diameter. Such a particle diameter indicates an average particle diameter (D50) where a cumulative volume is about 50 volume % in a particle size distribution. The particle size (D50) may be measured by a method well suitable to those skilled in the art, for example, by a particle size analyzer, or by a transmission electron microscopic image, or a scanning electron microscopic image. In one or more embodiments, a dynamic light-scattering measurement device is utilized to perform a data analysis, and the number of particles is counted for each particle size range, and from this, the average particle diameter (D50) value may be easily obtained through a calculation. The particle size may be measured by a laser diffraction method. The laser diffraction may be obtained by distributing particles to be measured in a distribution solvent and introducing it to a commercially available laser diffraction particle measuring device (e.g., MT 3000 available from Microtrac, Inc.), irradiating ultrasonic waves of about 28 kHz at a power of about 60 W, and calculating an average particle diameter (D50) in the 50% standard of particle distribution in the measuring device. Also, unless otherwise defined, in the present disclosure, the term “particle diameter” or “crystallite size” refers to an average diameter if (e.g., when) particles or crystallites are spherical and refers to an average major axis length if (e.g., when) particles or crystallites are non-spherical.

### Nano Zirconia

A negative electrode active material according to one or more embodiments may include a M-included nano zirconia (where, M is Y₂O₃, CeO₂, or Sc₂O₃), a nano silicon, and an amorphous carbon. The M-included nano zirconia (e.g., with nanometer scale dimensions) may have a particle diameter of about 300 nanometer (nm) or less.

The M-included nano zirconia may include a Y₂O₃-included nano zirconia, a CeO₂-included nano zirconia, a Sc₂O₃-included nano zirconia, and/or a (e.g., any suitable) combination thereof. In one or more embodiments, the M-included nano zirconia may be the Y₂O₃-included nano zirconia.

In one or more embodiment, the M-included nano zirconia refers to a nano-sized zirconia; (e.g., zirconia with nanometer scale dimensions), which is chemically stable at room temperature due to an addition of M into zirconia, and may have a particle form. For example, the M-included nano zirconia may be Y₂O₃-stabilized nano zirconia (YSZ), CeO₂-stabilized nano zirconia (CSZ), Sc₂O₃-stabilized nano zirconia (ScSZ), and/or a (e.g., any suitable) combination thereof.

Inclusion of the M-included nano zirconia in the negative electrode active material may provide, or render to exhibit, an improved thermal safety (e.g., of the negative electrode active material and/or the negative electrode). Such an aspect for improving thermal safety may be achieved or realized from inclusion of the M-included nano zirconia which includes M and has nano size of about 300 nm or less, in the negative electrode active material. If (e.g., when) nano zirconia without M is utilized, the safety of nano zirconia is relatively low and thus, the thermal aspect may be not realized. If (e.g., when) M-included zirconia of which size is not nano size, (for example is a micrometer size or more than about 300 nm), is included in the negative electrode active material, internal substantial uniformity of powder may be reduced.

In one or more embodiments, a particle diameter of the M-included nano zirconia, for example, an average particle diameter, may be about 300 nm or less, about 10 nm to about 300 nm, about 10 nm to about 250 nm, about 10 nm to about 200 nm, about 10 nm to about 150 nm, about 10 nm to about 100 nm, about 20 nm to about 100 nm, about 30 nm to about 100 nm, or about 30 nm to about 70 nm. If (e.g., when) the particle diameter of the M-included nano zirconia is within the described ranges, the thermal safety of the negative electrode active material may be greatly enhanced.

In one or more embodiments, an amount of the M-included nano zirconia may be, based on 100 wt % of the negative electrode active material, about 1 wt % or less, about 0.01 wt % to about 1 wt %, or about 0.03 wt % to about 0.8 wt %. If (e.g., when) the amount of the M-included nano zirconia satisfies the described ranges, the capacity loss may be minimized or reduced and more excellent or suitable thermal stability may be achieved or realized.

The nano silicon refers to silicon with a nano-size and may be silicon with a particle diameter of about 500 nm or less, and for example, may be silicon particle with a particle diameter of about 500 nm or less. The particle diameter of the silicon may be about 5 nm to about 500 nm, about 5 nm to about 400 nm, about 5 nm to about 300 nm, about 5 nm to about 200 nm, about 5 nm to about 100 nm, about 10 nm to about 100 nm, about 20 nm to about 100 nm, about 30 nm to 100 nm, about 40 nm to about 100 nm, about 50 nm to about 100 nm, or 50 nm to about 90 nm. If (e.g., when) such nano silicon is utilized together with the M-included nano zirconia, nano zirconia may be dispersed between nano silicon with relatively high Li integration, thereby further enhancing the thermal stability (e.g., of the negative electrode active material and/or the negative electrode).

An amount of the nano silicon may be, based on 100 wt % of the negative electrode active material, about 30 wt % to about 80 wt %, or about 35 wt % to about 70 wt %. If (e.g., when) the amount of the nano silicon is within the described ranges, higher specific capacity may be exhibited, and the deterioration of the battery due to the expansion may be more gradual (e.g., decreased).

An amount of the amorphous carbon may be, based on 100 wt % of the negative electrode active material, about 20 wt % to about 70 wt %, or about 30 wt % to about 60 wt %. If (e.g., when) the amount of the amorphous carbon is within the described ranges, the (e.g., size of the) internal pores (e.g., of the negative electrode active material) may be smaller (e.g., more reduced) and the amorphous carbon may (e.g., render to), more rigidly coat (e.g., on) the surface (e.g., of the negative electrode active material), thereby reducing the electrolyte consumption.

The amorphous carbon may be soft carbon, hard carbon, mesophase pitch carbide, sintered coke, and/or a (e.g., any suitable) combination thereof.

In the negative electrode active material according to one or more embodiments, the amorphous carbon may provide, or be presented as, a coating layer. For example, the negative electrode active material may include an agglomerated product (e.g., a secondary particle) where the M-included nano zirconia and nano silicon are agglomerated, and an amorphous carbon coating layer on a surface of the agglomerated product (e.g., a secondary particle). For example, the agglomerated product (e.g., a secondary particle) may include the M-included nano zirconia and the nano silicon.

A thickness of the amorphous carbon coating layer may be about 1 nm to about 2 micrometer (μm), about 1 nm to about 500 nm, about 10 nm to about 300 nm, or about 20 nm to about 200 nm. If (e.g., when) the thickness of the amorphous carbon coating layer is within the described ranges, the volume expansion of silicon may be well suppressed or reduced during charge and discharge.

In one or more embodiments, the negative electrode active material may further include crystalline carbon and the crystalline carbon may be included in the agglomerated product (e.g., a secondary particle). For example, the agglomerated product (e.g., a secondary particle) may be an agglomerated product (e.g., a secondary particle) where the M-included nano zirconia, the nano silicon, and the crystalline carbon are agglomerated.

In one or more embodiments, the crystalline carbon may be artificial graphite, natural graphite, and/or a (e.g., any suitable) combination thereof. The crystalline carbon may be of an unspecified shape, sheet shaped, flake shaped, spherical shaped, or fiber shape (e.g., in a form of fibers), and may be artificial graphite, natural graphite, and/or a (e.g., any suitable) combination thereof.

If (e.g., when) the negative electrode active material further includes crystalline carbon, an amount of the crystalline carbon may be about 1 wt % to about 20 wt % based on 100 wt % of the negative electrode active material and an amount of the amorphous carbon may be about 30 wt % to about 70 wt % based on 100 wt % of the negative electrode active material. An amount of the nano silicon may be about 20 wt % to about 70 wt % based on 100 wt % of the negative electrode active material. Although the negative electrode active material further includes the crystalline carbon, an amount of the M-included nano zirconia may be about 1 wt % or less based on 100 wt % of the negative electrode active material.

### Method of Preparing Negative Electrode Active Material

A negative electrode active material according to one or more embodiments may be prepared by the following procedures (e.g., acts or tasks).

A M-included nano zirconia and a nano silicon are prepared.

The M-included nano zirconia may be prepared by pulverizing a M-included zirconia. The pulverizing may be carried out by a milling technique, or may be carried out utilizing a bead mill or a ball mill. In one or more embodiments, it may be carried out utilizing at least two types (kinds) of the beads mill or at least two types (kinds) of the ball mill, each of a different size. The pulverization may be carried out in order to provide, or have, a particle diameter to be about 300 nm or less, about 10 nm to about 300 nm, about 10 nm to about 250 nm, about 10 nm to about 200 nm, about 10 nm to about 150 nm, about 10 nm to about 100 nm, about 20 nm to about 100 nm, about 30 nm to about 100 nm, or about 30 nm to about 70 nm.

The pulverization may be carried out utilizing a dry technique, or may be carried out by a wet technique utilizing a solvent. The solvent may be isopropyl alcohol, ethanol, methanol, butanol, propylene glycol, and/or a (e.g., any suitable) combination thereof.

The M-included zirconia may have a micrometer size, and for example, may be M-included zirconia with a size of about 1 μm to about 10 μm, but the present disclosure is not limited thereto.

The nano silicon may be prepared pulverizing silicon. The pulverization may be carried out by a milling procedure, or may be carried out utilizing a beads mill or a ball mill. The pulverization may be performed in order to provide, or have, a nano-sized silicon, and for example, in order to provide, or have, a particle diameter of about 100 nm or less, about 5 nm to about 100 nm, or about 50 nm to about 100 nm.

The pulverization may be carried out a dry technique, or may be carried out by a wet technique utilizing a solvent. The solvent may suitably be alcohols which do not oxidize the silicon particle and may be readily volatilized, and examples of which may be isopropyl alcohol, ethanol, methanol, butanol, propylene glycol, and/or a (e.g., any suitable) combination thereof.

The M-included nano zirconia and the nano silicon may be mixed. The mixing may be carried out in a solvent. The solvent may be isopropyl alcohol, ethanol, methanol, butanol, propylene glycol, and/or a (e.g., any suitable) combination thereof. A mixing ratio of the M-included zirconia and the nano silicon may be adjusted so that the amount of the M-included zirconia in the negative electrode active material is 1 wt % or less.

The resulting mixture is (e.g., of the M-included nano zirconia and the nano silicon) may be dried. The drying may be carried out by a spray drying. The spray drying may be carried out utilizing a spray dryer at a temperature of about 120° C. to about 200° C. The resulting dried product prepared by the preceding process may be an agglomerated product (e.g., a secondary particle) where the M-included nano zirconia and the nano silicon are agglomerated, as described elsewhere herein.

In mixing, crystalline carbon may be mixed together (e.g., with the agglomerated product, or with the M-included nano zirconia and the nano silicon), and this process may prepare a spray dried product which is an agglomerated product (e.g., a secondary particle) where the M-included nano zirconia, the nano silicon, and the crystalline carbon are agglomerated.

Thereafter, the spray dried product and an amorphous carbon precursor may be mixed. The amorphous carbon precursor may be at least one selected from among a phenol resin, a furan resin, an epoxy resin, polyacrylonitrile, a polyamide resin, a polyimide resin, a polyamideimide resin, synthesized pitch, petroleum-based pitch, coal-based pitch, meso pitch, tar, and/or a (e.g., any suitable) combination thereof.

A mixing ratio of the spray dried product and the amorphous carbon precursor may be a weight ratio of about 30:116 to about 70:50, or a weight ratio of about 40:100 to about 60:67.

The resulting mixed product may be heat-treated. The heat-treatment may be carried out at a temperature of about 600° C. to about 1,200° C., about 650° C. to about 1,100° C., for example about 700° C. to about 1,000° C. During this procedure, the amorphous carbon precursor may be converted to amorphous carbon. The heat-treatment may be carried out under an atmosphere such as nitrogen (N₂), argon atmosphere, and/or a (e.g., any suitable) combination thereof. The heat-treatment may be carried out for about 1 hour to about 5 hours, or about 1 hour to about 3 hours.

In one or more embodiments, the negative electrode active material may include a silicon-carbon composite, e.g., including the silicon nano particles and the amorphous carbon coating layer. If (e.g., when) the silicon-carbon composite includes silicon nano particles and the amorphous carbon coating layer, based on total 100 wt % of the silicon-carbon composite, an amount of the silicon nano particles may be about 30 wt % to about 70 wt %, or about 40 wt % to about 65 wt %. An amount of the amorphous carbon coating layer, based on the total 100 wt % of the silicon-carbon composite, about 30 wt % to about 70 wt %, or about 35 wt % to about 60 wt %.

In one or more embodiments, the silicon-carbon composite may further include crystalline carbon. If (e.g., when) the silicon-carbon composite further includes crystalline carbon, based on the total 100 wt % of the silicon-carbon composite, an amount of the silicon nano particles may be about 20 wt % to about 70 wt %, or about 25 wt % to about 65 wt %. Based on the total 100 wt % of the silicon-carbon composite, an amount of the amorphous carbon may be about 25 wt % to about 70 wt %, or about 25 wt % to about 60 wt %, and an amount of the crystalline carbon may be about 1 wt % to about 20 wt %, or about 5 wt % to about 15 wt %.

### <Rechargeable Lithium Battery>

Another embodiment provides a rechargeable lithium battery including a negative electrode, a positive electrode, and an electrolyte.

### Negative Electrode

The negative electrode includes a current collector, and a negative electrode active material layer on the current collector. The negative electrode active material layer includes the negative electrode active material according to one or more embodiments, and may further include a binder and/or a conductive material (e.g., an electron conductor).

For example, the negative electrode active material layer may include the negative electrode active material at about 90 wt % to about 99 wt %, the binder at about 0.5 wt % to about 5 wt %, and the conductive material at about 0 wt % to about 5 wt %. If (e.g., when) the negative electrode active material layer further includes the conductive material, an amount of the conductive material may be about 0.5 wt % to about 5 wt %.

The binder improves binding properties of negative electrode active material particles with one another and with the current collector. The binder may be a non-aqueous binder, an aqueous binder, and/or a (e.g., any suitable) combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, and/or a (e.g., any suitable) combination thereof.

The aqueous binder may include a styrene-butadiene rubber, a (meth)acrylated styrene-butadiene rubber, a (meth)acrylonitrile-butadiene rubber, a (meth)acryl rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinyl pyridine, chlorosulfonated polyethylene, latex, a polyester resin, a (meth)acrylic resin, a phenol resin, an epoxy resin, polyvinyl alcohol, and/or a (e.g., any suitable) combination thereof.

If (e.g., when) the aqueous binder is utilized as a negative electrode binder, a cellulose-based compound may be further utilized to provide viscosity. The cellulose-based compound includes one or more of (e.g., at least one of) carboxymethyl cellulose, hydroxypropylmethyl cellulose, methyl cellulose, or alkali metal salts thereof. The alkali metal may be Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, and/or a (e.g., any suitable) combination thereof.

The conductive material may be included to provide electrode conductivity (e.g., be an electron conductor), and any electrically conductive material may be utilized as a conductive material unless it causes a chemical change. Examples of the conductive material may be a carbon-based material such as natural graphite, artificial graphite, carbon black, acetylene black, ketjen black, a carbon fiber, a carbon nanofiber, carbon nanotube, and/or the like; a metal-based material of a metal powder or a metal fiber including copper, nickel, aluminum, silver, and/or the like; a conductive polymer such as a polyphenylene derivative; and/or a (e.g., any suitable) mixture thereof.

The current collector may include one selected from among a copper foil, a nickel foil, a stainless steel foil, a titanium foil, a nickel foam, a copper foam, a polymer substrate coated with a conductive metal, and/or a (e.g., any suitable) combination thereof, but the present disclosure is not limited thereto.

### Positive Electrode

The positive electrode for a rechargeable lithium battery may include a current collector and a positive electrode active material layer on the current collector. The positive electrode active material layer includes a positive electrode active material and may further include a binder and/or a conductive material (e.g., an electron conductor).

For example, the positive electrode may further include an additive that may be, or can serve as, a sacrificial positive electrode.

An amount of the positive electrode active material may be about 90 wt % to about 99.5 wt % based on 100 wt % of the positive electrode active material layer, and each amount of the binder and the conductive material may be about 0.5 wt % to about 5 wt % based on 100 wt % of the positive electrode active material layer.

The binder improves binding properties of positive electrode active material particles with one another and with a current collector. Examples of the binder may be polyvinyl alcohol, carboxymethyl cellulose, hydroxypropyl cellulose, diacetyl cellulose, polyvinylchloride, carboxylated polyvinylchloride, polyvinyl fluoride, an ethylene oxide-containing polymer, polyvinyl pyrrolidone, polyurethane, polytetrafluoroethylene, polyvinylidene fluoride, polyethylene, polypropylene, a styrene butadiene rubber, a (meth)acrylated styrene butadiene rubber, an epoxy resin, a (meth)acrylic resin, a polyester resin, nylon, and/or the like, but are not limited thereto.

The conductive material is included to provide electrode conductivity (e.g., be an electron conductor), and any electrically conductive material may be utilized as a conductive material unless it causes a chemical change. Examples of the conductive material may include a carbon-based material such as natural graphite, artificial graphite, carbon black, acetylene black, Ketjen black, carbon fiber, carbon nanofiber, carbon nanotube, and/or the like; a metal-based material of a metal powder or a metal fiber including copper, nickel, aluminum, silver, and/or the like; a conductive polymer such as a polyphenylene derivative; and/or a (e.g., any suitable) mixture thereof.

The current collector may include AI, but the present disclosure is not limited thereto.

### Electrolyte

The electrolyte for a rechargeable lithium battery may include a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, aprotic solvent, and/or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like.

The ester-based solvent may include methyl acetate, ethyl acetate, n-propyl acetate, dimethyl acetate, methyl propionate, ethyl propionate, decanolide, mevalonolactone, valerolactone, caprolactone, and/or the like.

The ether-based solvent may include dibutyl ether, tetraglyme, diglyme, dimethoxyethane, 2-methyltetrahydrofuran, 2,5-dimethyltetrahydrofuran, tetrahydrofuran, and/or the like. The ketone-based solvent may include cyclohexanone, and/or the like. The alcohol-based solvent may include ethanol, isopropyl alcohol, and/or the like and the aprotic solvent may include nitriles such as R—CN (wherein R is a C2 to C20 linear, branched, or cyclic hydrocarbon group, and may include a double bond, an aromatic ring, or an ether bond, and/or the like); amides such as dimethylformamide; dioxolanes such as 1,3-dioxolane, 1,4-dioxolane, and/or the like; sulfolanes, and/or the like.

The non-aqueous organic solvent(s) may be utilized alone or in combination of two or more.

If (e.g., when) utilizing a carbonate-based solvent, a cyclic carbonate and a chain carbonate may be mixed and utilized, and the cyclic carbonate and the chain carbonate may be mixed in a volume ratio of about 1:1 to about 1:9.

The lithium salt dissolved in the organic solvent supplies lithium ions in a battery, enables the general or suitable operation of a rechargeable lithium battery, and improves transportation of the lithium ions between positive and negative electrodes. Examples of the lithium salt include at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂), wherein x and y are integers of 1 to 20, lithium trifluoromethane sulfonate, lithium tetrafluoroethanesulfonate, lithium difluorobis(oxalato)phosphate (LiDFOB), and lithium bis(oxalato)borate (LiBOB).

### Separator

Depending on the type or kind of the rechargeable lithium battery, a separator may be present between the positive electrode and the negative electrode. The separator may include polyethylene, polypropylene, polyvinylidene fluoride, a multilayer film of two or more layers thereof, a mixed multilayer film such as a polyethylene/polypropylene two-layer separator, a polyethylene/polypropylene/polyethylene three-layer separator, a polypropylene/polyethylene/polypropylene three-layer separator, and/or the like.

The separator may include a porous substrate and a coating layer including an organic material, an inorganic material, and/or a (e.g., any suitable) combination thereof on one or both (e.g., opposite) surfaces of the porous substrate.

The porous substrate may be a polymer film formed of any one selected from among polyolefin such as polyethylene and polypropylene, polyester such as polyethylene terephthalate and polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or copolymer(s) of two or more thereof, or mixture(s) of two or more thereof.

The organic material may include a polyvinylidene fluoride-based polymer or a (meth)acrylic polymer.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and/or a (e.g., any suitable) combination thereof, but the present disclosure is not limited thereto.

The organic material and the inorganic material may be mixed in one coating layer, or a coating layer including an organic material and a coating layer including an inorganic material may be stacked.

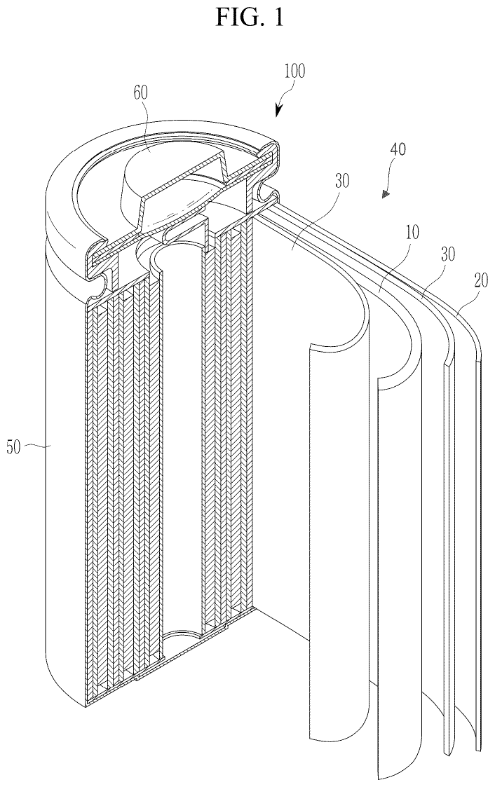

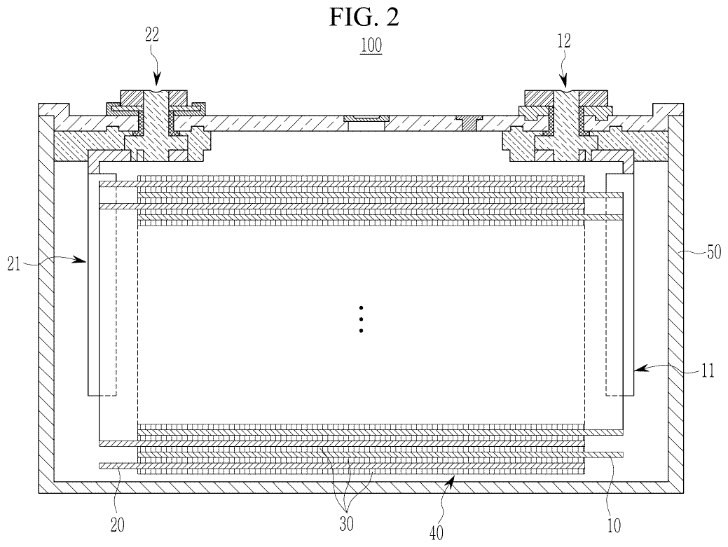

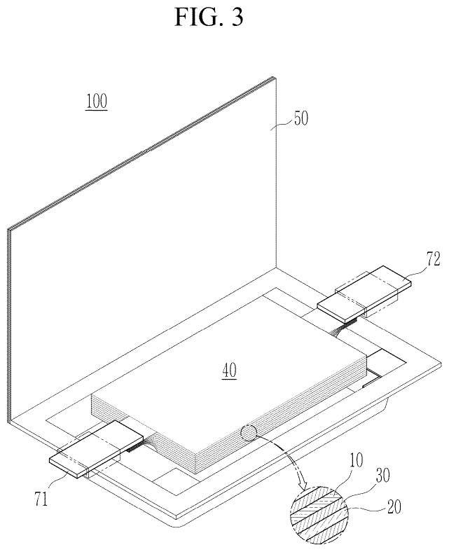

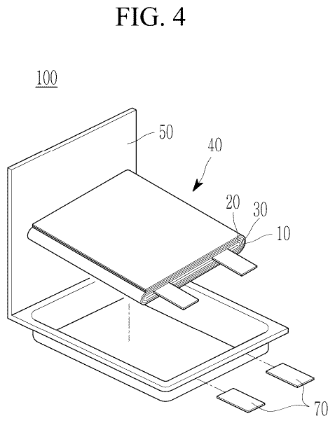

The rechargeable lithium batteries of the present disclosure may be classified into cylindrical, prismatic, pouch, or coin-type or kind batteries, and/or the like depending on their shape. FIG. 1 to FIG. 4 are each a schematic view illustrating a rechargeable lithium battery according to one or more embodiments. FIG. 1 shows a cylindrical battery, FIG. 2 shows a prismatic battery, and FIG. 3 and FIG. 4 show pouch-type or kind batteries. Referring to FIGS. 1 to 4, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution. The rechargeable lithium battery 100 may include a sealing member 60 sealing the case 50, as shown in FIG. 1. In FIG. 2, the rechargeable lithium battery 100 may include a positive lead tab 11, a positive terminal 12, a negative lead tab 21, and a negative terminal 22. As shown in FIG. 3, the rechargeable lithium battery 100 may include electrode tabs, which may be, for example, a positive electrode tab 71 and a negative electrode tab 72 serving as an electrical path for inducing the current formed in the electrode assembly 40 to the outside. As shown in FIG. 4, the rechargeable lithium battery 100 includes electrode tabs 70.

The rechargeable lithium battery according to one or more embodiments may be utilized with, or applied to, automobiles, mobile phones, and/or one or more suitable types (kinds) of electric devices, as non-limiting examples.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or +30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

Hereinafter, examples of the present disclosure and comparative examples are described. These examples, however, are not in any sense to be interpreted as limiting the scope of the present disclosure.

### EXAMPLES

### Example 1

Y₂O₃-stabilized zirconia (YSZ) with an average particle diameter (D50) of 1 micrometer (μm) was pulverized in an ethanol solvent utilizing a 0.1 millimeter (mm) beads mill and a 0.4 mm beads mill to prepare a Y₂O₃-stabilized nano zirconia (i.e., a M-included nano zirconia, M is Y₂O₃) with an average particle diameter (D50) of 100 nanometer (nm).

Silicon with an average particle diameter (D50) of 1 μm was pulverized in an ethanol solvent utilizing a 0.1 mm beads mill to prepare a nano silicon with an average particle diameter (D50) of 100 nm.

The Y₂O₃-stabilized nano zirconia and the nano silicon were mixed in an ethanol solvent in order to have an amount of the Y₂O₃-stabilized nano zirconia to be 1 wt % in a final negative electrode active material. The mixture was spray-dried utilizing a spray drier at a temperature range of 120° C. to 170° C. According to this procedure, an agglomerated product (e.g., a secondary particle) where the Y₂O₃-stabilized nano zirconia and nano silicon were agglomerated, was prepared.

The resulting spray-dried product (agglomerated product (e.g., a secondary particle)) and meso (mesophase) pitch were mixed in order to have a weight ratio of 40:60, respectively, in the final product, and the obtained mixture was heat-treated in a furnace having a temperature of 1000° C. under an N₂ atmosphere for 2 hours to prepare a negative electrode active material including an agglomerated product (e.g., a secondary particle) where the Y₂O₃-stabilized nano zirconia and the nano silicon were agglomerated and a soft carbon coating layer on the surface of the agglomerated product (e.g., a secondary particle).

In the prepared negative electrode active material, an amount of the Y₂O₃-stabilized nano zirconia was 1 wt %, an amount of the nano silicon was 39 wt %, and the amount of the soft carbon was 60 wt %. The soft carbon coating layer had a thickness of 100 nm.

97.5 wt % of the negative electrode active material, 1.5 wt % of carboxymethyl cellulose, and 1 wt % of a styrene butadiene rubber were mixed in a water solvent to prepare a negative electrode active material layer slurry.

The negative electrode active material layer slurry was coated on a Cu foil current collector, dried, and pressurized to prepare a negative electrode including a negative electrode active material layer on the current collector.

The negative electrode, a lithium metal counter electrode, and an electrolyte were utilized to fabricate a half-cell under a general procedure. The electrolyte was utilized by dissolving 1 M LiPF₆ in a mixed solvent of ethylene carbonate and dimethyl carbonate (3:7 volume ratio).

### Example 2

A negative electrode active material was prepared by the same procedure as in Example 1, except that CeO₂-stabilized zirconia (CSZ) with an average particle diameter (D50) of 1 μm was utilized instead of the Y₂O₃-stabilized zirconia (YSZ) with an average particle diameter (D50) of 1 μm.

A negative electrode and a half-cell were fabricated utilizing the negative electrode active material by the same procedure as in Example 1.

### Example 3

A negative electrode active material was prepared by the same procedure as in Example 1, except that Sc₂O₃-stabilized zirconia (ScSZ) with an average particle diameter (D50) of 1 μm was utilized instead of the Y₂O₃-stabilized zirconia (YSZ) with an average particle diameter (D50) of 1 μm.

A negative electrode and a half-cell were fabricated utilizing the negative electrode active material by the same procedure as in Example 1.

### Example 4

A negative electrode active material was prepared by the same procedure as in Example 1, except that the Y₂O₃-stabilized nano zirconia with an average particle diameter (D50) of 50 nm, was prepared.

A negative electrode and a half-cell were fabricated utilizing the negative electrode active material by the same procedure as in Example 1.

### Example 5

A negative electrode active material was prepared by the same procedure as in Example 1, except that the Y₂O₃-stabilized nano zirconia and the nano silicon were mixed so that an amount of the Y₂O₃-stabilized nano zirconia to be 0.5 wt % in the final negative electrode active material was 0.5 wt %. In the prepared negative electrode active material, an amount of the Y₂O₃-stabilized nano zirconia was 0.5 wt %, an amount of the nano silicon was 39.5 wt %, and the amount of the soft carbon was 60 wt %. The soft carbon coating layer had a thickness of 100 nm.

A negative electrode and a half-cell were fabricated utilizing the negative electrode active material by the same procedure as in Example 1.

### Comparative Example 1

A negative electrode active material was prepared by the same procedure as in Example 1, except that the Y₂O₃-stabilized nano zirconia and the nano silicon were mixed in order to have an amount of the Y₂O₃-stabilized nano zirconia to be 10 wt % in the final negative electrode active material.

A negative electrode and a half-cell were fabricated utilizing the negative electrode active material by the same procedure as in Example 1.

### Comparative Example 2

Zirconia with an average particle diameter (D50) of 1 μm was pulverized in an ethanol solvent utilizing a 0.1 mm bead mill and a 0.4 mm beads mill to prepare nano zirconia with an average particle diameter (D50) of 100 nm.

A negative electrode active material was prepared by the same procedure as in Example 1, except that the nano zirconia and the nano silicon were mixed in order to have an amount of the nano zirconia to be 10 wt % in the final negative electrode active material.

A negative electrode and a half-cell were fabricated utilizing the negative electrode active material by the same procedure as in Example 1.

### Comparative Example 3

Y₂O₃-stabilized zirconia (YSZ) with an average particle diameter (D50) of 1 μm was pulverized in an ethanol solvent utilizing a 0.1 mm beads mill and a 0.4 mm beads mill to prepare Y₂O₃-stabilized nano zirconia with an average particle diameter (D50) of 500 nm.

A negative electrode active material was prepared by the same procedure as in Example 1, except that the Y₂O₃-stabilized nano zirconia and the nano silicon were mixed in order to have an amount of the Y₂O₃-stabilized nano zirconia to be 10 wt % in the final negative electrode active material.

A negative electrode and a half-cell were fabricated utilizing the negative electrode active material by the same procedure as in Example 1.

### Experimental Example 1) Evaluation of Thermal Safety

The half-cells according to Examples 1 to 5 and Comparative Examples 1 to 3 were twice charged and discharged at 0.2 C and a 3.0 V to 4.3 V cut-off voltage (formation) and once charged at 0.2 C and a 4.3 V cut-off voltage. From the fully charged cell, the negative electrode was separated under an argon atmosphere and then 5 milligram (mg) of the negative electrode active material was collected in the resulting negative electrode, and then the onset temperature at which the exotherm was abruptly stated was measured utilizing a differential scanning calorimetry device. The difference scanning calorimetry analysis was conducted by increasing a temperature to 400° C. from 40° C. at an increasing rate of 10° C./minute to measure a change in calorimetry.

### Experimental Example 2) Evaluation of Cycle-Life Characteristic

The half-cells according to Examples 1 to 5 and Comparative Examples 1 to 3 were charged and discharged at 1 C in a range of 0.01 V to 1.5 V for 50 cycles. Charge and discharge conditions and a cut-off condition were as described herein. Charge: constant current/constant voltage, 0.01 V/0.01 C cut-off Discharge: constant current, 1.5 V cut-off

A ratio of 50^{th} discharge capacity relative to a 1^{st} discharge capacity was calculated. The results are shown in Table 1 as capacity retention.

TABLE 1

| | DSC Onset | |
|---|---|---|
| | temperature | Capacity retention |
| | (° C.) | (%) |
| Example 1 | 124 | 96.2 |
| Example 2 | 126 | 96.5 |
| Example 3 | 127 | 96.1 |
| Example 4 | 128 | 96.9 |
| Example 5 | 123 | 97.1 |
| Comparative | 105 | 88.1 |
| Example 1 | | |
| Comparative | 115 | 89.7 |
| Example 2 | | |
| Comparative | 109 | 88.5 |
| Example 3 | | |

As shown in Table 1, the negative electrode active material of each of Examples 1 to 5 had higher onset temperature at which the exotherm was abruptly started, than the negative electrode active material of each of Comparative Examples 1 to 3, and thus, the safety was excellent or suitable and excellent or suitable capacity retention was exhibited.

A battery management system (BMS) device, and/or any other relevant devices or components according to embodiments of the present disclosure described herein may be implemented utilizing any suitable hardware, firmware (e.g., an application-specific integrated circuit), software, or a combination of software, firmware, and hardware. For example, the components of the device may be formed on one integrated circuit (IC) chip or on separate IC chips. Further, the components of the device may be implemented on a flexible printed circuit film, a tape carrier package (TCP), a printed circuit board (PCB), or formed on one substrate. Further, the components of the device may be a process or thread, running on one or more processors, in one or more computing devices, executing computer program instructions and interacting with other system components for performing the functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, and/or the like. Also, a person of skill in the art should recognize that the functionality of computing devices may be combined or integrated into a single computing device, or the functionality of a particular computing device may be distributed across one or more other computing devices without departing from the scope of the present disclosure.

While the present disclosure has been described in connection with what is presently considered to be practical example embodiments, it is to be understood that the present disclosure is not limited to the disclosed embodiments, but, on the contrary, is intended to cover one or more suitable modifications and equivalent arrangements included within the spirit and scope of the appended claims, and equivalents thereof.

What is claimed is:

1. A negative electrode active material, comprising:
a M-included nano zirconia, wherein M is Y₂O₃, CeO₂, or Sc₂O₃, the M-included nano zirconia being in a form of particles and having a particle diameter of about 300 nanometer (nm) or less;
a nano silicon; and
an amorphous carbon.

2. The negative electrode active material as claimed in claim 1, wherein the M-included nano zirconia has the particle diameter of about 10 nanometer (nm) to about 300 nanometer (nm).

3. The negative electrode active material as claimed in claim 1, wherein the M-included nano zirconia has the particle diameter of about 10 nanometer (nm) to about 250 nanometer (nm).

4. The negative electrode active material as claimed in claim 1, wherein an amount of the M-included nano zirconia is about 1 wt % or less based on 100 wt % of the negative electrode active material.

5. The negative electrode active material as claimed in claim 1, wherein an amount of the M-included nano zirconia is about 0.01 wt % to about 1 wt % based on 100 wt % of the negative electrode active material.

6. The negative electrode active material as claimed in claim 1, wherein the negative electrode active material comprises an agglomerated product in which the M-included nano zirconia and the nano silicon are agglomerated, and a coating layer of the amorphous carbon.

7. The negative electrode active material as claimed in claim 6, wherein the coating layer has a thickness of about 1 nanometer (nm) to about 2 micrometer (μm).

8. The negative electrode active material as claimed in claim 1, wherein the negative electrode active material further comprises crystalline carbon.

9. The negative electrode active material as claimed in claim 6, wherein the agglomerated product further comprises crystalline carbon.

10. The negative electrode active material as claimed in claim 1, wherein M is Y₂O₃.

11. The negative electrode active material as claimed in claim 1, wherein the nano silicon is in a form of particles and has a particle diameter of about 500 nanometer (nm) or less.

12. The negative electrode active material as claimed in claim 11, wherein the particle diameter of the nano silicon is about 5 nanometer (nm) to about 500 nanometer (nm).

13. The negative electrode active material as claimed in of claim 1, wherein an amount of the nano silicon is about 30 wt % to about 80 wt % based on 100 wt % of the negative electrode active material.

14. The negative electrode active material as claimed in claim 1, wherein an amount of the amorphous carbon is about 20 wt % to about 70 wt % based on 100 wt % of the negative electrode active material.

15. A rechargeable lithium battery, comprising:
a negative electrode comprising the negative electrode active material as claimed in claim 1;
a positive electrode; and
an electrolyte.

16. The rechargeable lithium battery as claimed in claim 15, wherein an amount of the M-included nano zirconia is about 0.01 wt % to about 1 wt % based on 100 wt % of the negative electrode active material.

17. The rechargeable lithium battery as claimed in claim 15, wherein the negative electrode active material comprises an agglomerated product in which the M-included nano zirconia and the nano silicon are agglomerated, and a coating layer of the amorphous carbon.

18. The rechargeable lithium battery as claimed in claim 17, wherein the coating layer has a thickness of about 1 nanometer (nm) to about 2 micrometer (μm).

19. The rechargeable lithium battery as claimed in claim 15, wherein the negative electrode active material further comprises crystalline carbon.

20. The rechargeable lithium battery as claimed in claim 15, wherein M is Y₂O₃.
